(19) United States
(12) Patent Application Publication
(10) Pub. No.: US 2026/0361731 A1
(43) Pub. Date: Nov. 12, 2026

(54) UNIFIED SECURITY ANALYSIS MANAGEMENT

(71) Applicant: Abnormal AI, Inc., Las Vegas, NV (US)

(72) Inventors: Sanjay Jeyakumar, El Cerrito, CA (US); Abhijit Bagri, Atlanta, GA (US); Lavania O. Nair, Chicago, IL (US); Michael Douglas Kralka, London (GB); Alexander Joseph Vetras, Portland, OR (US)

(21) Appl. No.: 19/204,265

(22) Filed: May 9, 2025

(51) Int. Cl. H04L 9/40

(52) U.S. Cl. CPC H04L 63/1416

(57) ABSTRACT

A specific data item of a first-party that has been identified as a security threat due to a first security analysis by a third-party service provider is accessed. A second security analysis on the specific data item is performed by a second-party service provider different from the third-party service provider. An action for the specific data item to be performed by the third-party service provider is handled via a platform of the second-party service provider based on the second security analysis.

### BACKGROUND OF THE INVENTION

Information Technology (IT) service solutions, such as cloud-based email platforms or IT account management systems, perform complex and resource-intensive tasks. In addition to providing their core functionality, such as handling email communications or managing user accounts, these IT service provider solutions often provide additional default services, such as a default security analysis implementation for detecting security threats. While such default implementations offer essential capabilities, they are often limited in scope and configurability. To address these limitations, extensions offered by service providers can be used to extend or customize the default functionality. For example, a third-party provider may offer advanced security threat analysis that surpasses the capabilities of the default security implementation.

These extensions, however, are often designed to replace the default implementations entirely, rather than integrate with them. As a result, users must choose between the default and the extension, with limited or no capability for interoperability between the two, or the ability to compare results between the two before selecting a desired outcome. This disjointed architecture prevents seamless coordination across services, limits flexibility, and increases operational complexity. Accordingly, there exists a need for a unified management framework that allows multiple service providers, including both default and extended service provider solutions, to interoperate in a coordinated and efficient manner. Such a solution would enable more configurable and customizable service solution outcomes and improve overall system usability and security.

### BRIEF DESCRIPTION OF THE DRAWINGS

Various embodiments of the invention are disclosed in the following detailed description and the accompanying drawings.

FIG. 1 is a block diagram illustrating an embodiment of a system for providing unified security analysis management.

FIG. 2 is a block diagram illustrating an embodiment of a unified security analysis service.

FIG. 3 is a flow chart illustrating an embodiment of a process for managing security analysis results using a unified approach.

FIG. 4 is a flow chart illustrating an embodiment of a process for performing an initial security analysis by an initial service provider.

FIG. 5 is a flow chart illustrating an embodiment of a process for performing a secondary security analysis by a secondary service provider.

FIG. 6 is a flow chart illustrating an embodiment of a process for performing a release remediation action based on unified security analysis results of different service providers.

FIG. 7 is a flow chart illustrating an embodiment of a process for performing actions based on unified security analysis results of different service providers.

FIG. 8 is a functional diagram illustrating a programmed computer system for providing unified security analysis management.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Unified security analysis management is disclosed. Using the disclosed techniques and systems, a unified approach to security analysis can be achieved for information technology (IT) services such as email and user account management. The unified security analysis results can be further managed using a unified security analysis management service. For example, for an email service, a primary email service can function as an intake service provider for inbound (and/or outbound) email. The intake email service provider can perform security analysis on the applicable data items, such as inbound or incoming emails. The default security analysis can include identifying and quarantining malicious emails and allowing identified non-malicious emails to flow to a user's inbox. In various embodiments, the initial security analysis performed by this first service provider functions as a first security analysis pass. A second service provider, such as an AI-driven security analysis service, can perform a second security analysis pass on the same data items including data items identified as malicious and quarantined by the first service provider. In traditional systems, the second service provider is unable to access items quarantined by the first service provider and only performs the additional second security analysis pass on items not caught by the intake service provider. Using an interoperability layer, a unified approach is achieved, and the second service provider can access and perform security analysis on the data items quarantined by the first service provider. By allowing both service providers to perform their own respective security analysis on a data item, the results from two different service providers can be compared. In some embodiments, the more accurate or desired result is selected. For example, a false positive identified by the first service provider can be identified by the second service provider as safe and released from the first service provider's quarantine. As another example, a false negative identified by the first service provider and allowed to pass undetected can be identified by the second service provider and treated as malicious. In various embodiments, the best result can be manually or automatically selected. In some embodiments, a selection can be automatically selected based on past manual selections and/or configuration settings.

In some embodiments, the unified security analysis approach includes a user interface that provides a single-pane or unified view of security analysis results. For example, the second service provider can provide a view that displays the security analysis results of the first and second service provider side-by-side. The included results can show threat scores determined by each service provider among other security analysis results. From the unified view, users can quickly and easily isolate false positives identified as malicious by the first service provider but safe by the second service provider. The unified security analysis management service further allows the user to release a false positive from the quarantine of the first service provider. For example, an email falsely identified and quarantined as malicious by the first service provider can be released by the second service provider and allowed to flow into a user's email inbox. In some embodiments, the release is automated and performed automatically without manual user intervention. For example, when a discrepancy in security analysis results is identified between the first and second service providers, the second service provider can automatically release a false positive from the quarantine initiated by the first service provider. In some embodiments, an item may be manually released on the first occurrence and subsequent occurrences of the same security threat or security threat campaign can be automated and released automatically.

In some embodiments, based on the identified results of the second service provider, the security analysis performed on the second service provider can be iteratively improved. For example, an AI-driven second service provider relying on one or more trained AI models can be retrained based on an action performed by the first and/or second service provider. The newly trained model can be applied by the second service provider to improve overall security analysis results despite a potentially static first service provider. This is particularly useful when changes or updates to the first service provider are difficult to implement, are infrequent, are costly, and/or may require a different approach, such as a more conservative approach to threat detection. In various embodiments, using the disclosed unified approach, the second service provider can implement a higher precision and more accurate security analysis process to address deficiencies or limited configurability options in the first service provider.

In some embodiments, a specific data item of a first-party that has been identified as a security threat due to a first security analysis is accessed by a third-party service provider. For example, an email addressed to a user is identified as malicious and quarantined by the intake email cloud service provider. The intake email cloud service provider is a third-party service provider performing a first security analysis. In some embodiments, a second security analysis is performed on the specific data item by a second-party service provider different from the third-party service provider. For example, an AI-driven unified security analysis service is a second-party service provider different from the intake email cloud service provider. The AI-driven unified security analysis service can access and perform its own security analysis on the quarantined email to determine whether the email is actually malicious. In some embodiments, an action for the specific data item to be performed by the third-party service provider is handled via a platform of the second-party service provider based on the second security analysis. For example, an action can be performed to release the quarantined email based on the security analysis result performed by the AI-driven unified security analysis service. Once identified as a false positive that should not be quarantined, the AI-driven unified security analysis service can initiate the release of the quarantined email by the intake email cloud service provider. In various embodiments, the release action can be handled automatically and/or triggered manually, such as by the user and/or by a security administrator via a unified security analysis management interface.

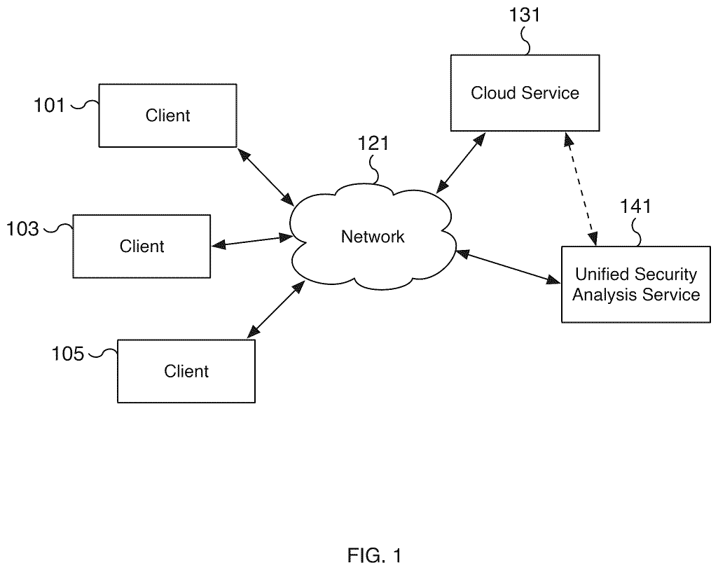

FIG. 1 is a block diagram illustrating an embodiment of a system for providing unified security analysis management. Using the disclosed techniques and systems, different security analysis solutions can be unified and managed via a single unified view. In the example shown, an IT service provided via cloud service 131 for clients such as clients 101, 103, and 105 is analyzed for security analysis results by both cloud service 131 and unified security analysis service 141. Clients 101, 103, and 105 are communicatively connected to cloud service 131 and unified security analysis service 141 via network 121. Similarly, cloud service 131 and unified security analysis service 141 are communicatively connected to one another via network 121. Network 121 can be a public or private network. In some embodiments, network 121 is a public network such as the Internet. In various embodiments, cloud service 131 is a messaging service and clients such as clients 101, 103, and/or 105 can access cloud service 131 to fulfill messaging requirements such as sending and receiving emails. In addition to its core functionality, cloud service 131 can implement additional features such as a default security analysis implementation allowing it to quarantine malicious items at cloud service 131. Unified security analysis service 141 is configured to interoperate with cloud service 131 and performs its own security analysis on items of cloud service 131, identifying security threats using its own security analysis implementation. In some embodiments, the security analysis implementation of unified security analysis service 141 is an advanced AI-driven threat detection process. Unified security analysis service 141 further provides a unified view of the security analysis results for both cloud service 131 and unified security analysis service 141, allowing users to manage cloud service 131 from a unified view. For example, using unified security analysis service 141, a user can release items quarantined by cloud service 131 based on the results of the security analysis performed by unified security analysis service 141. As disclosed herein, the unified security analysis management performed by unified security analysis service 141 can be applied to different IT services, such as inbound messaging, outbound messaging, and/or user account management, among others. Although the unified solution of FIG. 1 may at times be described with respect to messaging services, such as email or chat messages, the solution is applicable for other IT domains and allows for unified management of other actions such as actions related to a user account compromise, a new user account creation, and/or a user account suspension, among others.

In some embodiments, clients 101, 103, and 105 are each a network client device for interfacing with cloud service 131 and/or unified security analysis service 141. For example, clients 101, 103, and/or 105 can correspond to users of an organization configured to access a messaging service such as an email service offered by cloud service 131. As another example, clients 101, 103, and/or 105 can correspond to information security personnel or other users with authorized security credentials that utilize unified security analysis service 141 for performing security responsibilities, including managing threat detection for supported services such as cloud service 131. For example, clients corresponding to an authorized security administrator can utilize unified security analysis service 141 to manage and perform actions in response to security threats detected on items of cloud service 131, such as detected malicious emails. One example action includes releasing an item quarantined by cloud service 131 that has been identified by cloud service 131 as malicious but as a false positive by unified security analysis service 141.

In some embodiments, cloud service 131 is a cloud-based platform for providing IT services such as messaging or account management services. Examples of messaging services can include email, group or workplace chat or communication services, text and/or multimedia messaging services, and instant messaging services, among others. Although only a cloud service 131 is shown in FIG. 1, multiple cloud services can be supported, such as different email services and/or one or more email services along with other IT services, such as a group chat service or an account management service. In various embodiments, items managed by cloud service 131, such as email messages, are analyzed for potential threats by a default security analysis implementation offered by cloud service 131. The security analysis performed by cloud service 131 can identify and quarantine malicious items. The quarantine process can provide a barrier that prevents an item, such as an email or account, from being accessed by users or other services. In various embodiments, the quarantine barrier can only be accessed internally by cloud service 131 or externally by an interoperability layer implemented by unified security analysis service 141.

In some embodiments, unified security analysis service 141 is a platform for performing unified management of security analysis results from different service providers. In the example shown, unified security analysis service 141 provides unified management of security analysis results performed by both cloud service 131 and unified security analysis service 141. In various embodiments, the security analysis performed by unified security analysis service 141 offers more advanced features, higher accuracy, improved efficiency, and more customization than the default implementation provided by cloud service 131. Rather than replace the security analysis performed by cloud service 131, the security analysis performed by unified security analysis service 141 can be run in parallel with cloud service 131, and the security analysis results of the two service providers can be compared against one another. In various embodiments, the results are provided by unified security analysis service 141 in a single pane user interface that offers a unified view of the different service provider security analysis results. Unified security analysis service 141 can further provide unified management functionality, such as functionality for performing actions on the items managed and/or analyzed by the different service providers. For example, unified security analysis service 141 can release an item from quarantine or unlock a disabled user account, among other actions. As another example, different service providers and their security analysis results can be compared within the unified view, and the best result can be selected and applied. When applied to email threat analysis, an email identified as a false positive and quarantined by cloud service 131 can be also analyzed by unified security analysis service 141. The email threat analysis scores from each analysis can be viewed via a unified view. When a false positive is quarantined by cloud service 131, the falsely identified email can be released from quarantine by unified security analysis service 141 based on the security analysis results of unified security analysis service 141. In various embodiments, the release can be performed manually or automatically. Moreover, the differences between analysis results and actions performed based on those differences can be used to further improve the security analysis performed by unified security analysis service 141.

In various embodiments, the security analysis performed by unified security analysis service 141 utilizes an AI-driven threat detection model. The AI model(s) used by unified security analysis service 141 can be further updated based on newly detected threats including threats based on discrepancies between security analysis results of different service providers. In some embodiments, the models are updated based on updates or changes to user preferences, such as the level of a threat that must be detected for an email to be quarantined. In various embodiments, the security analysis performed by unified security analysis service 141 can be continuously updated and improved, offering an improvement over default, potentially static, and/or infrequently updated implementations offered by other service providers.

Although single instances of some components have been shown to simplify the diagram of FIG. 1, additional instances of any of the components shown in FIG. 1 may exist. For example, cloud service 131 may be implemented by one or more service provider servers and unified security analysis service 141 may be implemented by one or more unified security analysis service provider servers. In some embodiments, some of the servers and their functionalities may be merged. Additionally, clients 101, 103, and 105 are example client devices. Although three clients are shown (clients 101, 103, and 105), many more additional clients can exist. Similarly, although only a single cloud service is shown (cloud service 131), many more cloud services including messaging and/or other IT services such as account management services, file sharing services, chat services, etc. can be supported and managed via unified security analysis service 141. In some embodiments, components not shown in FIG. 1 may also exist and/or the network configuration of the included components may differ from what is shown.

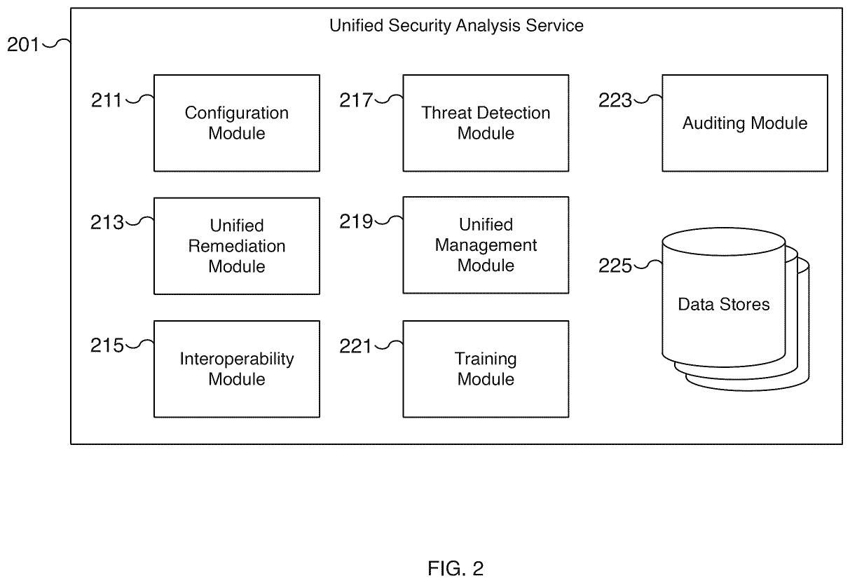

FIG. 2 is a block diagram illustrating an embodiment of a unified security analysis service. In the example shown, unified security analysis service 201 includes configuration module 211, unified remediation module 213, interoperability module 215, threat detection module 217, unified management module 219, training module 221, auditing module 223, and data stores 225. Using unified security analysis service 201, security analysis results performed by multiple different service providers including by unified security analysis service 201 can be managed in a unified manner such as via a single pane or unified user interface. For example, threat scores assessed by different service providers can be viewed, compared, and the desired result can be selected as an outcome and subsequent actions can be performed based on the selected outcome. In various embodiments, the selection can be manual, automated, and/or a combination of both manual and automated responses. In some embodiments, unified security analysis service 201 is unified security analysis service 141 of FIG. 1 and at least one of the service providers managed by unified security analysis service 201 can include cloud server 131 of FIG. 1.

In some embodiments, configuration module 211 is a processing module for configuring a unified security analysis service including for configuring the integration and management of different service providers. For example, configuration module 211 can process configuration parameters provided by security personnel for configuring interoperation with other service providers such as a cloud-based email service. With respect to different security analysis results of different service providers, configuration module 211 can be used to configure how to respond to detected discrepancies between the different security analysis results of the different managed service providers, such as when to release an item from quarantine or when an identified positive result by a service provider is actually a false positive based on a different service provider's analysis result. In some embodiments, the configuration parameters are received via a web interface such as a web application or web service.

In some embodiments, unified remediation module 213 is a processing module for resolving identified threats, such as malicious emails and user accounts that have been taken over and/or compromised. Unified remediation module 213 may analyze and detect discrepancies between the different security analysis results and implement a remediation plan based on a detected discrepancy. For example, actions performed by unified remediation module 213 can be triggered automatically without user intervention and/or manually such as to release items from quarantine, quarantine items, change the status of items such as the status of an email or a user account, and/or update users on identified threats, among other actions. In some embodiments, unified remediation module 213 utilizes interoperability module 215 to interface with other service providers, such as to release an item quarantined by another service provider.

In some embodiments, interoperability module 215 is a processing module for interoperating with other service providers including service providers that are typically closed and difficult to access. For example, service providers may offer only limited access to items, such as via application programming interfaces (APIs), particularly items that have been quarantined. Interoperability module 215 is a processing module that addresses the interface limitations of service providers. For example, interoperability module 215 can implement caching and/or synching features to improve performance when accessing items from a service provider. As another example, interoperability module 215 can implement permission and authentication functionality such as for securely accessing a service provider. Other interoperability functionality can be implemented as well such as compatibility and/or translation layers for protocol and schema differences, conflict resolution solutions, and/or adherence to security and compliance policies and laws, among other features or requirements, to ensure interoperability with different service providers.

In some embodiments, threat detection module 217 is a processing module for performing security analysis and detecting security threats. For example, using threat detection module 217, a security threat such as a malicious email or a user account compromise or takeover attempt can be detected depending on the IT application domain. In various embodiments, the detected threats include a determined threat assessment, threat risk, confidence, and/or severity scores. For example, a confidence score can be determined that ranks how likely the detected threat is an actual threat. Similarly, a severity score can be determined that ranks the severity of the detected threat such as the amount of damage or harm that can result from the threat in the event that the threat is an actual threat. Additional context of a detected threat such as a description of the threat, suggested remediation solutions, and/or tips for avoiding similar threats can be generated as well. In some embodiments, threat detection module 217 may be AI-driven and may utilize one or more machine learning models including deep learning and/or large language models to identify potential security threats, determine corresponding scores such as a threat, confidence, and/or severity score, and/or to determine remediation options. Additionally, in various embodiments, one or more user accounts impacted by a detected security threat are determined. The impacted user accounts, corresponding scores, and/or other detected threat data can be provided to unified remediation module 213 to resolve, mitigate, and/or neutralize the security threat, to training module 221 for retraining one or more AI models, to unified management module 219 for management of the detected threat, and/or to auditing module 223 for auditing the security analysis, among other modules of unified security analysis service 201.

In some embodiments, unified management module 219 is a processing module for managing actions related to the security analysis of different service providers. For example, using unified management module 219, a user can review the different security analysis results of different service providers including default results as well as the results determined by threat detection module 217. In some embodiments, the results are accessible via a user interface such as a single-pane user interface that presents the results in a unified view. When presented in this manner, users can easily compare the results of different providers and select the most appropriate result. For example, users can easily identify when one service provider has determined an email is malicious and another has determined the same email is safe. The conflict or discrepancies can be resolved via unified management module 219. For example, a default security analysis implementation may quarantine an email identified wrongly as malicious. Based on threat detection module 217 identifying the email as safe, a management action can be performed via unified management module 219 to release the email from quarantine and mark the email as safe. In some embodiments, the actions are performed automatically without user intervention and/or manually. In various embodiments, unified management module 219 is integrated with auditing module 223, allowing a user to review audit trails, such as audit trails of an item managed by a service provider or a security analysis result. In some embodiments, unified management module 219 is accessible via a web service such as a web application and/or via application programming interfaces.

In some embodiments, training module 221 is a processing module for training models for performing security analysis including for performing threat detection. In some embodiments, training module 221 operates to train the models employed by the other modules such as to train the machine learning (ML) model(s) employed by threat detection module 217. For example, training module 221 can train the threat detection model(s) used by threat detection module 217 for detection of security threats based on threats previously identified by threat detection module 217 and/or actions performed via unified management module 219. The training data may be user-or group-specific so that the ML model(s) are able to perform personalized analysis. In various embodiments, training module 221 further implements a retraining pipeline (or simply “pipeline”) in order to protect against novel threats including newly identified threats. At a high level, the pipeline may be representative of a series of steps that, when executed by training module 221, cause the models employed by threat detection module 217 to be retrained. By consistently training the models using up-to-date information, unified security analysis service 201 can protect against novel threats that would otherwise escape detection, including those that escape the detection of other service providers, and help enforce compromise detection consistency as new threats are identified. For example, newly identified threats detected by threat detection module 217 and/or actions performed via unified management module 219 can be used by training module 221 for retraining.

In some embodiments, auditing module 223 is a processing module for auditing security analysis results. For example, using auditing module 223, security analysis performed on an item, such as an email or a user account, and/or security analysis performed around an event can be audited. The security analysis results, including the results performed by other service providers can be tracked and retraced. Similarly, actions performed based on the results can be audited allowing a user to retrace the steps that were performed. In some embodiments, auditing module 223 includes a reporting module for generating security analysis reports including reports that unify the results of different service providers. For example, auditing module 223 can generate notifications highlighting the discrepancies between the security analysis results performed by different service providers and the suggested remediation option and/or actions that should or were performed.

In some embodiments, data stores 225 are one or more data stores used for providing unified security analysis management. For example, data stores 225 can be used to store data associated with security analysis results including for caching data items such as emails and account profiles. Data stores 225 can also store configuration data such as preferred remediation approaches, tolerance to severity scores, preferences for automatic or manual release of quarantined items, and/or configuration data for generating customized audit or reporting content, among other data. In various embodiments, other stored data can include threat analysis data including threat logs and/or AI models and related model data. In the example shown, data stores 225 can be utilized by the different modules of unified security analysis service 201. Although shown as integrated with unified security analysis service 201, data stores 225 can include distributed and/or third-party data storage services.

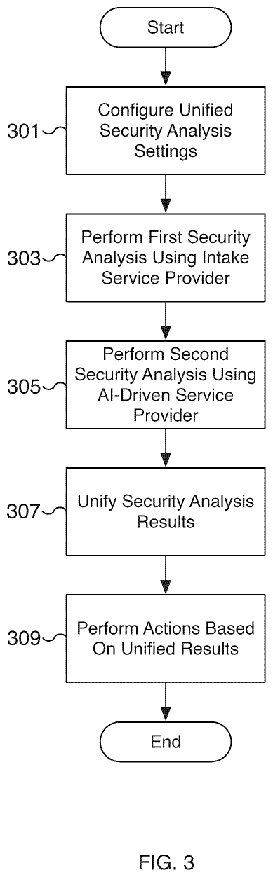

FIG. 3 is a flow chart illustrating an embodiment of a process for managing security analysis results using a unified approach. Using the process of FIG. 3, security analysis implementations from different service providers can be performed and their results can be managed from a unified view. For example, a first service provider can function as an intake service provider, implementing its own default security analysis. A unified security analysis service, functioning as a second service provider, can interoperate with the first service provider while also independently performing its own security analysis on items analyzed by the first service provider. Rather than replace the default security analysis performed at intake, which often cannot be disabled, the security analysis implemented by the unified security analysis service is configured to be performed sequentially after the default security analysis is complete. The competing results can be unified by the unified security analysis service and actions on the analyzed items can be handled via a unified security analysis service from a unified user interface. In some embodiments, the unified security analysis service is unified security analysis service 141 of FIG. 1 and/or unified security analysis service 201 of FIG. 1. In some embodiments, the intake service provider is cloud service 131 of FIG. 1.

At 301, unified security analysis settings are configured. For example, settings for managing security analysis results using a unified approach are configured via a unified security analysis service. In some embodiments, the configuration includes configuring an interoperability layer for accessing other service providers. For example, the configuration performed may include configuring authentication and security settings for remotely accessing a first service provider and configuring preferences for managing conflicts when differences arise between security analysis results performed by the different service providers. In various embodiments, threat detection settings and preferences can be configured as well.

At 303, a first security analysis is performed using an intake service provider. For example, an intake service provider analyzes a data item and determines a security analysis result. In some embodiments, the intake service provider is a cloud messaging service, and the analysis can include identifying malicious items such as malicious emails. The security analysis performed by the intake service provider may be a default security analysis implementation, which may be difficult to configure and customize for different organizations. In some embodiments, the default security analysis implementation may only receive infrequent updates. When a malicious email is detected, the email may be quarantined and may be typically hidden from other downstream services, such as other threat detection systems. In some embodiments, these hidden or quarantined items are inaccessible from external service providers that lack an interoperability layer.

At 305, a second security analysis is performed using an AI-driven service provider. For example, data items including items already analyzed by the intake service provider are analyzed to determine a second security analysis result. In various embodiments, the security analysis performed by the intake service provider at 303 is completed before the second security analysis is performed at 305. For example, the two security analysis passes are performed sequentially. The analysis performed by the second service provider at 305 is an AI-driven analysis using one or more trained machine learning models. In some embodiments, an interoperability layer is used to access data items under the management of the intake service provider. For example, using an interoperability layer, the second security analysis can be performed even on items that are quarantined and/or hidden from access including access by other service providers. In some embodiments, the second security analysis results include a threat assessment score, a severity score, a confidence score, and/or, in the event a threat is identified, a description of an identified threat and/or suggested remediation plan. In some embodiments, the security analysis results include determining a threat category for the data item. Example categories for data items such as emails can include attack, borderline, spam, graymail, or safe categories.

At 307, security analysis results are unified. For example, the security analysis results performed by the intake service provider at 303 and the AI-driven second service provider at 305 are unified by a unified security analysis service. The unified results can be presented in a unified view such as a single-pane user interface that allows for the different results to be efficiently compared and evaluated against one another. For example, the unified results can be presented by displaying both the first security analysis results determined at 303 by the intake service provider and the second security analysis results determined at 305 by the AI-driven service provider. The results of the different service providers can be displayed side-by-side in a unified user interface view. In some embodiments, actions including proposed remediation actions are presented in a unified management view that allows for handling of actions to be performed on data items related to the security analysis results. For example, a release action can be presented for an email identified as malicious by the intake service provider but safe by the AI-driven service provider. As another example, an account suspension action can be presented for an account that has been compromised.

At 309, actions are performed based on the unified results. For example, one or more actions initiated by the unified security analysis service are performed for a data item. The actions, such as releasing an email from quarantine or from a quarantine folder, can be performed at any of the service providers including the intake service provider. For example, using an interoperability layer, the unified security analysis service can handle and perform actions on items at external service providers including at the intake service provider. In various embodiments, the actions performed can be automated and performed automatically. Alternatively, the action can be performed manually such as in response to a request initiated via a unified management interface. In some embodiments, the automated actions are performed based on past manually initiated actions.

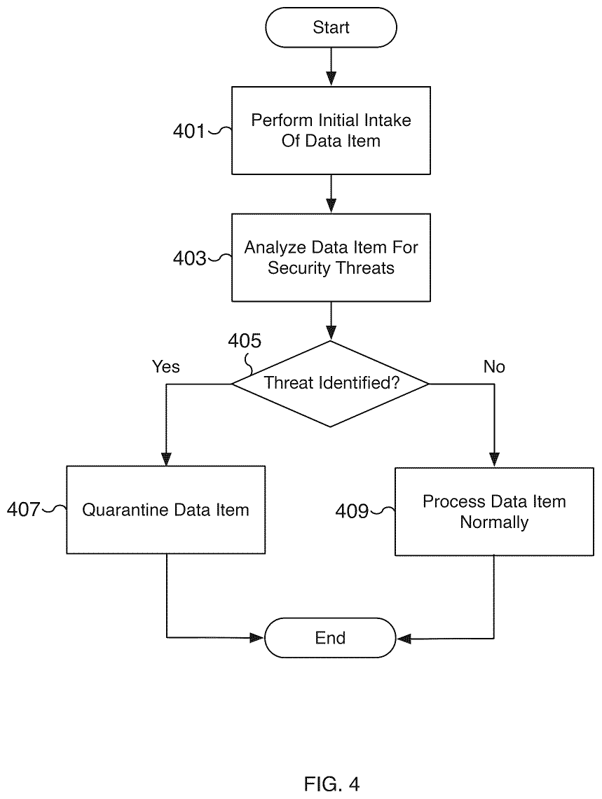

FIG. 4 is a flow chart illustrating an embodiment of a process for performing an initial security analysis by an initial service provider. For example, an intake service provider can analyze data items such as inbound emails for security threats. The analysis performed can be the initial security analysis performed on the data item. Based on the security analysis results, an analyzed item can be quarantined and/or removed from the normal processing path. In some embodiments, once quarantined, the item is made inaccessible from external service providers that lack an interoperability layer. In some embodiments, the process of FIG. 4 is performed at 303 of FIG. 3 by an initial service provider such as an email cloud service. In some embodiments, the initial service provider is cloud service 131 of FIG. 1.

At 401, an initial intake of the data item is performed. For example, a data item such as an email is initially processed during an intake step. The initial service provider, such as an email cloud service provider, functions as an intake service provider for receiving the data item. In some embodiments, the email is intended for a user and the email is received at the service provider. Other types of data items other than an inbound email are appropriate as well, such as an outbound or outgoing email or a user account event, such as a user account suspension or the adding of a new user account.

At 403, the data item is analyzed for security threats. For example, a data item such as an inbound email is analyzed for security threats such as to identify malicious emails. The security analysis performed can correspond to the first assessment on the data item for security threats. In some embodiments, the security analysis is a default implementation of the intake service provider. The implementation may be a generic implementation that is designed to address general use cases and/or the needs of a wide variety of users but may not offer the needed configurability, customization, or adaptability that a specific enterprise requires.

At 405, a determination is made whether a threat is identified. In the event a threat is identified, processing proceeds to 407, where the data item associated with the threat can be quarantined. In the event a threat is not identified, processing proceeds to 409, where the data item is processed normally.

At 407, the data item is quarantined. For example, once a threat associated with the data item is identified, the data item is quarantined. In some embodiments, the data item is an email that has been identified as malicious, and the email is immediately quarantined to remediate the identified security threat. The quarantine process can include marking the item as hidden and making it inaccessible from external service providers that lack an interoperability layer. As another example, a user account that has been identified as having been taken over or compromised can be quarantined to suspend unauthorized access to the user account and its functionality.

At 409, the data item is processed normally. For example, no security threat is identified for the data item and the data item is processed normally. In some embodiments, the data item is an email and since no security threat is identified, the email is delivered to the user's inbox following the normal email processing flow. As another example, a data item associated with a user account or user account event can be found to have no associated security threats and therefore no changes are made to suspend the user account and/or actions initiated by the user account.

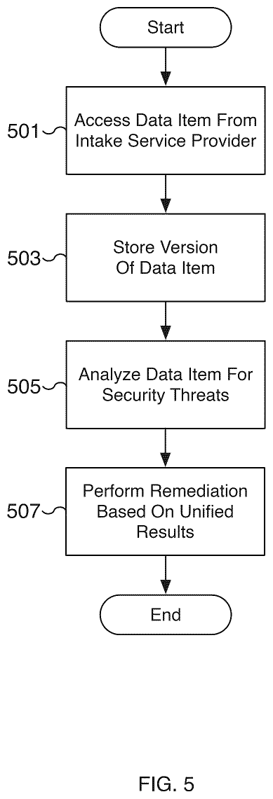

FIG. 5 is a flow chart illustrating an embodiment of a process for performing a secondary security analysis by a secondary service provider. For example, a secondary service provider such as a unified security analysis service provider can analyze data items such as inbound or incoming emails for security threats. The security analysis performed by the secondary service can be performed to supplement an initial security analysis performed by another service provider, such as an intake service provider. In various embodiments, the secondary service provider utilizes an interoperability layer to access data items, such as data items maintained by the intake or initial service provider. In some embodiments, the process of FIG. 5 is performed at 305, 307, and/or 309 of FIG. 3 by a unified security analysis service provider such as unified security analysis service 141 of FIG. 1 and/or unified security analysis service 201 of FIG. 2.

At 501, a data item is accessed from an intake service provider. For example, using an interoperability layer, a unified security analysis service provider can access a data item from another service provider, such as an intake service provider, that is otherwise inaccessible. In some embodiments, the data item is an email and the email is accessed remotely and retrieved. For example, the data item can be downloaded from the intake service provider. In some embodiments, the data item is downloaded to the unified security analysis service provider from the intake service provider. In some embodiments, the data item may relate to an event and data of the event and/or related user account is accessed and retrieved.

At 503, a version of the data item is stored. For example, the data item accessed at 501 is stored. In some embodiments, a version of the data item is stored, such as a compressed version and/or a summary version of the data item. For example, an email may be accessed at 501 but portions of the email, such as larger attachments of the email, may not be stored whereas the main body and headers of the email may be stored. In some embodiments, the stored version of the data item is a cached version that allows a representation of the data item to be accessed even when connectivity to the intake service provider can be challenging such as due to performance and/or efficiency reasons. In various embodiments, the stored version of the data item may be synced with the original version of the data item. The stored version can be stored at the unified security analysis service provider and/or at a data store associated with the unified security analysis service provider.

At 505, the data item is analyzed for security threats. For example, a security analysis is performed on the data item to analyze the data item for security threats. In various embodiments, the implementation of the security analysis is AI-driven and provides superior results than other security analysis implementations such as a default implementation utilized by the intake service provider. In some embodiments, the implementation of the security analysis used at 505 is customized and configured to the particular needs and use cases of the data item and its associated user and/or organization. As part of the security analysis, the security analysis results can be recorded for later retrieval, such as for unified management and auditing purposes.

In some embodiments, the analysis for security threats can determine a threat assessment score, a severity score, a confidence score, and/or, in the event a threat is identified, a description of an identified threat and/or suggested remediation plan. In some embodiments, the analysis results include determining a threat category for the data item. Example categories for data items such as emails can include attack, borderline, spam, graymail, or safe categories.

At 507, remediation is performed based on a unified security analysis result. For example, one or more steps of a remediation process can be performed based on the security analysis results of 505 that are unified with results of other service providers. In some embodiments, the remediation includes initiating actions at remote service providers such as at a remote intake service provider. For example, a quarantined data item can be released by the intake service provider based on the security analysis result. In some embodiments, step 507 is performed after the results of different service providers are unified and the differences in results are identified. Moreover, the remediation can be initiated and performed automatically, such as based on discrepancies determined between the security analysis result of different service providers and/or initiated manually such as triggered by a unified security analysis management tool. For example, using a unified view of security analysis results, a security administrator or user can manually initiate an action based on the different security analysis results, including by selecting the appropriate outcome when the results from different security providers differ. As part of the remediation process, the performed actions can be recorded for later retrieval, such as for unified management and auditing purposes.

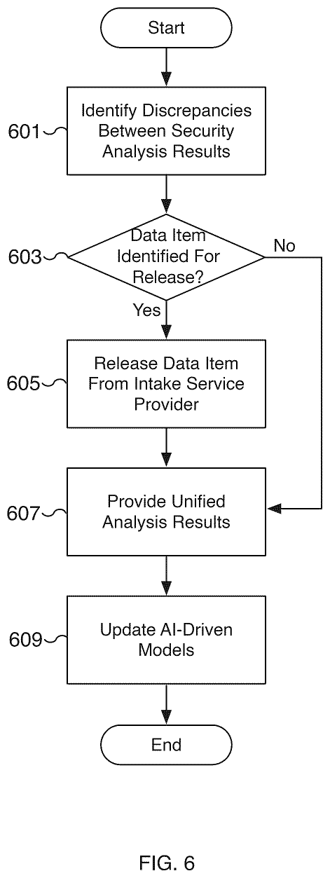

FIG. 6 is a flow chart illustrating an embodiment of a process for performing a release remediation action based on unified security analysis results of different service providers. For example, a unified security analysis service can unify the security analysis results determined by different service providers such as by an intake service provider and by a security analysis implementation of the unified security analysis service. The unified results allow for unified management of analyzed data items and related events including the unified management of remediation actions. Based on the unified results, one or more remediation actions can be performed. In the example process described in FIG. 6, the release of a quarantined item from an intake service provider is initiated by the unified security analysis service when an item has been identified for release. The release action can be performed automatically or triggered manually, such as via a unified security analysis management interface. In some embodiments, the process of FIG. 6 is performed at 307 and/or 309 of FIG. 3 and/or at 507 of FIG. 5 by a unified security analysis service such as unified security analysis service 141 of FIG. 1 and/or unified security analysis service 201 of FIG. 2. In some embodiments, the intake service provider from which a data item is released is cloud service 131 of FIG. 1.

At 601, discrepancies between security analysis results are identified. For example, the unified security results are analyzed to identify discrepancies between security analysis results of an intake service provider and the unified security analysis service. An example of a discrepancy is the identification of an email as malicious by one provider but as safe by the other provider. In some embodiments, when an email is identified as malicious by the intake service provider, the email is marked as malicious and quarantined. This quarantine action removes access to the email, potentially making it inaccessible including to the intended recipient and external service providers. In various embodiments, only the intake service provider and external service providers with an interoperability layer are able to access a quarantined data item. Based on the determined discrepancies, the data item can be identified for release from quarantine. For example, a security administrator can review the unified results and determine that the intake service provider mistakenly identified the data item as malicious, and based on the recommended action of the unified security analysis service, the security administrator can mark the data item as safe and to be released from quarantine. As another example, the determination to override the result of the intake service provider can be performed automatically such as by configuring the unified security analysis service to prioritize its security analysis results over the intake service provider.

At 603, a determination is made whether a data item is quarantined and identified for release. In the event the data item is quarantined and identified for release, processing proceeds to 605. In the event the data item is not quarantined and identified for release, processing proceeds to 607.

At 605, the data item is released from the intake service provider. For example, using an interoperability layer of the unified security analysis service, the unified security analysis service initiates the release of the data item managed and placed in quarantine by the intake service provider. The data item, such as an email, can be marked as safe and allowed to be processed by the normal processing flow. For example, a previously quarantined false positive email is released from a quarantine folder and placed in the user's inbox folder as a safe email.

At 607, unified analysis results are provided. For example, the unified analysis results are updated and provided via the unified security analysis service such as via a unified management tool. In some embodiments, the management tool includes a unified view that allows the results to be reviewed and audited. For example, a user or security administrator can review and/or audit the different results of the different providers and potential quarantine release actions can be performed. In some embodiments, when a data item is displayed, selecting the data item provides the user with the ability to trace the security analysis performed by each service provider. In some embodiments, the results are provided via a notification system such as via daily or weekly updates or reports. In some embodiments, the results are provided via a dashboard such as a dashboard with a unified view or a single-pane interface.

At 609, one or more AI models are updated. For example, one or more AI-models used by the unified security analysis service can be updated, if appropriate. The update can be based on the actions (or non-actions) performed and the training data may include data collected by determining security analysis discrepancies and the actions performed (or not performed) in response to the determined discrepancies. For example, actions initiated by the user and/or discrepancies identified between differences in the service provider security analysis results can be used to train or retrain AI-models used by the unified security analysis service. In some embodiments, the trained AI machine learning model is the model used for performing security analysis and for identifying security threats. In some embodiments, the trained machine learning model is the model used for determining the appropriate remediation steps, such as when to release a data item such as a quarantined email. In some embodiments, the training is performed at intervals or based on triggering events, such as after a certain period of time or a number of events has passed and/or after a certain number of actions have been performed.

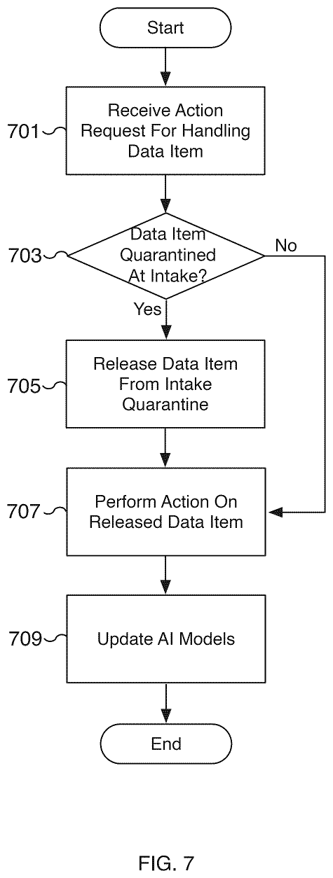

FIG. 7 is a flow chart illustrating an embodiment of a process for performing actions based on unified security analysis results of different service providers. For example, an action can be initiated and performed from a unified security analysis service. The performed action can include initiating the action at the unified security analysis service and performing at least part of the action at a remote service provider such as an intake service provider. In various embodiments, an action is handled by the unified security analysis service and delegated to the appropriate service provider. In some embodiments, the action is performed automatically without user intervention and/or manually, such as based on configured preferences or via a unified management interface. In some embodiments, the process of FIG. 7 is performed at 309 of FIG. 3 by a unified security analysis service such as unified security analysis service 141 of FIG. 1 and/or unified security analysis service 201 of FIG. 2. In some embodiments, the external service provider performing at least part of the action is cloud service 131 of FIG. 1.

At 701, a request to perform an action for handling a data item is received. For example, a request to perform an action, such as to release an email from quarantine, to suspend a user account, to perform a remediation action in response to an account compromise or takeover attempt, to add a new user account, or to categorize a data item, among other actions, is received. In various embodiments, the request can be initiated automatically, such as based on configured preferences and/or based on an AI model prediction. In some embodiments, the request is initiated by a user or security administrator, such as via a unified security analysis management interface of a unified security analysis service.

At 703, a determination is made whether the data item is quarantined at an intake service provider. In the event the data item is quarantined at an intake service provider, processing proceeds to 705. In the event the data item is not quarantined at an intake service provider, processing proceeds to 707.

At 705, the data item is released from the intake quarantine. For example, the data item is first released from quarantine at the intake service provider before the action requested at 701 can be performed. In various embodiments, the release is initiated by the unified security analysis service using an interoperability interface to communicate with the intake service provider. Once the data item is released, one or more other actions or sub-actions can be performed on the data item. In some embodiments, the requested action is the quarantine release, and no additional actions are performed.

At 707, the action is performed on the released data item. For example, the action requested at 701 is performed on the data item. In some embodiments, the action is performed by the intake service provider and/or by another service provider but is initiated by the unified security analysis service. As described above, the unified security analysis service can be configured to interface with other service providers via known interfaces, such as published application programming interfaces (APIs), and/or via an interoperability interface of the unified security analysis service. In some embodiments, the action performed is the quarantine release action performed at 705 and no additional action is performed at 707. In some embodiments, one or more sequences of actions and/or sub-actions are performed, and each can be performed sequentially and/or in parallel as requested. For example, an action to suspend a user account, to remediate an account compromise or takeover attempt, or to create a new user account may each require multiple sub-actions. In various embodiments, the action performed at 707 is recorded and the results can be reviewed and/or audited.

At 709, one or more AI models are updated. For example, one or more AI-models used by the unified security analysis service can be updated, if appropriate. The update can be based on the actions (or non-actions) performed and the training data may include data collected when the actions are performed (or not performed). For example, actions initiated by the user and/or automatically performed can be used to train or retrain AI-models used by the unified security analysis service. In some embodiments, the trained AI machine learning model is the model used for handling action requests. In some embodiments, the trained machine learning model is the model used for determining the appropriate steps for performing the requested action. In some embodiments, the training is performed at intervals or based on triggering events, such as after a certain period of time and/or after a certain number of actions have been performed.

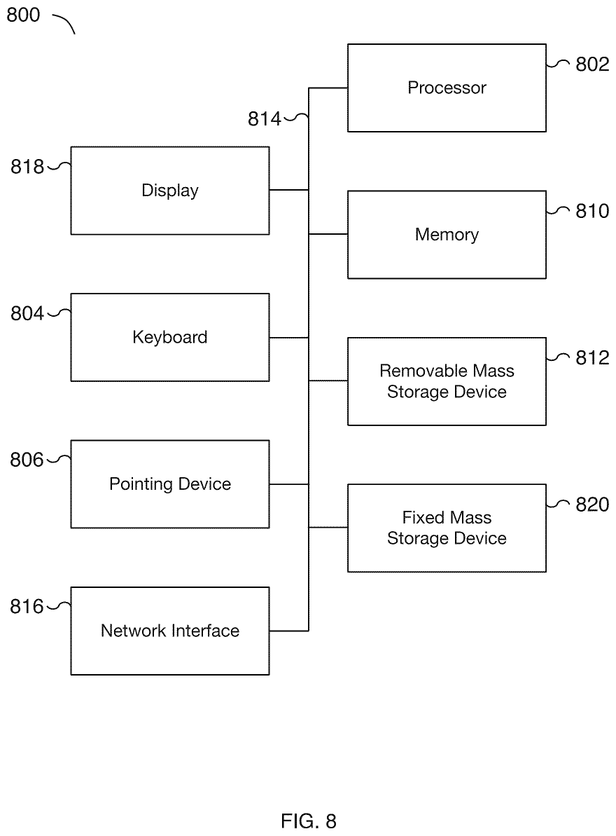

FIG. 8 is a functional diagram illustrating a programmed computer system for providing unified security analysis management. As will be apparent, other computer system architectures and configurations can be utilized for providing unified security analysis management. Examples of computer system 800 include clients 101, 103, and 105 of FIG. 1, one or more computers of cloud service 131 of FIG. 1, one or more computers of unified security analysis service 141 of FIG. 1, and/or one or more computers of unified security analysis service 201 of FIG. 2. Computer system 800, which includes various subsystems as described below, includes at least one microprocessor subsystem (also referred to as a processor or a central processing unit (CPU)) 802. For example, processor 802 can be implemented by a single-chip processor or by multiple processors. In some embodiments, processor 802 is a general purpose digital processor that controls the operation of the computer system 800. Using instructions retrieved from memory 810, the processor 802 controls the reception and manipulation of input data, and the output and display of data on output devices (e.g., display 818). In various embodiments, one or more instances of computer system 800 can be used to implement at least portions of the processes of FIGS. 3-7.

Processor 802 is coupled bi-directionally with memory 810, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 802. Also as is well known in the art, primary storage typically includes basic operating instructions, program code, data and objects used by the processor 802 to perform its functions (e.g., programmed instructions). For example, memory 810 can include any suitable computer-readable storage media, described below, depending on whether, for example, data access needs to be bi-directional or unidirectional. For example, processor 802 can also directly and very rapidly retrieve and store frequently needed data in a cache memory (not shown).

A removable mass storage device 812 provides additional data storage capacity for the computer system 800, and is coupled either bi-directionally (read/write) or unidirectionally (read only) to processor 802. For example, storage 812 can also include computer-readable media such as magnetic tape, flash memory, PC-CARDS, portable mass storage devices, holographic storage devices, and other storage devices. A fixed mass storage 820 can also, for example, provide additional data storage capacity. The most common example of mass storage 820 is a hard disk drive. Mass storages 812, 820 generally store additional programming instructions, data, and the like that typically are not in active use by the processor 802. It will be appreciated that the information retained within mass storages 812 and 820 can be incorporated, if needed, in standard fashion as part of memory 810 (e.g., RAM) as virtual memory.

In addition to providing processor 802 access to storage subsystems, bus 814 can also be used to provide access to other subsystems and devices. As shown, these can include a display monitor 818, a network interface 816, a keyboard 804, and a pointing device 806, as well as an auxiliary input/output device interface, a sound card, speakers, and other subsystems as needed. For example, the pointing device 806 can be a mouse, stylus, track ball, or tablet, and is useful for interacting with a graphical user interface.

The network interface 816 allows processor 802 to be coupled to another computer, computer network, or telecommunications network using a network connection as shown. For example, through the network interface 816, the processor 802 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 802 can be used to connect the computer system 800 to an external network and transfer data according to standard protocols. For example, various process embodiments disclosed herein can be executed on processor 802, or can be performed across a network such as the Internet, intranet networks, or local area networks, in conjunction with a remote processor that shares a portion of the processing. Additional mass storage devices (not shown) can also be connected to processor 802 through network interface 816.

An auxiliary I/O device interface (not shown) can be used in conjunction with computer system 800. The auxiliary I/O device interface can include general and customized interfaces that allow the processor 802 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 8 is but an example of a computer system suitable for use with the various embodiments disclosed herein. Other computer systems suitable for such use can include additional or fewer subsystems. In addition, bus 814 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
accessing a specific data item of a first-party that has been identified as a security threat due to a first security analysis by a third-party service provider;
performing by a second-party service provider different from the third-party service provider, a second security analysis on the specific data item; and
handling via a platform of the second-party service provider based on the second security analysis, an action for the specific data item to be performed by the third-party service provider.

2. The method of claim 1, wherein the first security analysis is completed before the second security analysis is performed.

3. The method of claim 1, wherein the action for the specific data item includes releasing the specific data item from a quarantine folder.

4. The method of claim 1, wherein the action for the specific data item is performed automatically without user intervention by the first-party.

5. The method of claim 1, wherein performing by the second-party service provider different from the third-party service provider, the second security analysis on the specific data item includes:
downloading the specific data item of the first-party from the third-party service provider;
storing the specific data item of the first-party at the second-party service provider for a duration; and
recording a result of the second security analysis on the specific data item.

6. The method of claim 1, further comprising displaying for the specific data item both a first security analysis result of the first security analysis by the third-party service provider and a second security analysis result of the second security analysis performed by the second-party service provider.

7. The method of claim 1, wherein the second security analysis determines a threat score determined by the second-party service provider.

8. The method of claim 1, wherein the second security analysis determines a threat category.

9. The method of claim 8, wherein category types of the threat category includes attack, borderline, spam, graymail, or safe.

10. The method of claim 1, further comprising training a machine learning model of the second-party service provider based on the action, handled via the platform of the second-party service provider based on the second security analysis, for the specific data item to be performed by the third-party service provider.

11. The method of claim 1, wherein the specific data item is an inbound or outbound email.

12. The method of claim 1, wherein the security threat is associated with a user account.

13. The method of claim 1, wherein the action for the specific data item is associated with suspending a user account, remediating an account compromise attempt, or adding a new user account.

14. The method of claim 1, further comprising:
determining that analysis results of the first security analysis by the third-party service provider differ from results of the second security analysis performed by the second-party service provider.

15. A system, comprising:
one or more processors configured to:
access a specific data item of a first-party that has been identified as a security threat due to a first security analysis by a third-party service provider;
perform by a second-party service provider different from the third-party service provider, a second security analysis on the specific data item; and
handle via a platform of the second-party service provider based on the second security analysis, an action for the specific data item to be performed by the third-party service provider; and
a memory coupled to the one or more processors, wherein the memory is configured to provide the one or more processors with instructions.

16. The system of claim 15, wherein the first security analysis is completed before the second security analysis is performed.

17. The system of claim 15, wherein the action for the specific data item includes releasing the specific data item from a quarantine folder.

18. The system of claim 15, wherein the action for the specific data item is performed automatically without user intervention by the first-party.

19. The system of claim 15, wherein performing by the second-party service provider different from the third-party service provider, the second security analysis on the specific data item includes to:
download the specific data item of the first-party from the third-party service provider;
store the specific data item of the first-party at the second-party service provider for a duration; and
record a result of the second security analysis on the specific data item.

20. A computer program product, the computer program product being embodied in a non-transitory computer readable storage medium and comprising computer instructions for:
accessing a specific data item of a first-party that has been identified as a security threat due to a first security analysis by a third-party service provider;
performing by a second-party service provider different from the third-party service provider, a second security analysis on the specific data item; and
handling via a platform of the second-party service provider based on the second security analysis, an action for the specific data item to be performed by the third-party service provider.
